(19) United States
(12) Patent Application Publication
(10) Pub. No.: US 2026/0149760 A1
(43) Pub. Date: May 28, 2026

(54) SYSTEMS AND METHODS FOR MANAGING SOFTWARE SERVICES

(71) Applicant: SAP SE, Walldorf (DE)

(72) Inventor: Hui Li, Shanghai (CN)

(21) Appl. No.: 18/962,425

(22) Filed: Nov. 27, 2024

(51) Int. Cl. H04L 67/61

(52) U.S. Cl. CPC H04L 67/61

(57) ABSTRACT

Embodiments of the present disclosure include techniques for managing software services. In one embodiment, a computer system periodically sends requests to, and receives responses from, a plurality of software services. Based on the responses, the system determines if the services are available. A plurality of application services accessing the software services send usage performance data. The system stores availability indicators and QoS values for the software services. The system may further store prices. The system selects software services for the application services to ensure minimum QoS levels are being achieved. Software services in the same category may also be selected based on price.

### BACKGROUND

The present disclosure relates generally to computer software systems, and in particular, to systems and methods for managing software services.

More and more software systems are migrating to cloud based software as a service (SaaS) models. In a SaaS system, in addition to the functional modules developed by the SaaS provider, it is also necessary to integrate many third-party services using APIs. For example, in a SaaS system for tourism product distribution, it is often required to inherit the map positioning service(s), weather forecast service(s), air ticket booking service(s), online payment APIs, etc. from multiple different software service providers. Additionally, for the same functionality module (e.g., maps), there are often many different vendors offering this functionality but each is using its own third-party API. These services are similar in functionality but vary greatly in quality of service (QoS) (e.g., response time, error rate), and pricing.

On the other hand, SaaS usually supports multi-tenancy, where different groups of users (typically different employees at different companies) are different tenants that run on a SaaS software system. However, different tenants sign different Service Level Agreements (SLAs) with the SaaS provider, in which the different QoS of the SaaS service access is defined. The different tenants may also have different requirements for accessing third-party services and therefore using third-party APIs. For example, some tenants have very strict response time requirements and relatively less strict success rate requirements and can tolerate some error rates (which can be handled by some fault tolerance mechanisms). Some tenants have very strict success rate requirements and less strict response time requirements and can tolerate some response time delays. If the QoS of the tenant's access to the SaaS product is not met, the SaaS provider may have to offer some kind of compensation, and if the customer's experience is severely degraded, such a customer may not renew the contract with the SaaS provider.

Therefore, when tenants access a SaaS, if the operations the tenants require rely upon a third-party service, how to manage and/or choose the right service, and corresponding API, may pose significant technical problems (e.g., an N-to-M technical problem pertaining to choosing a service where a user from a tenant may utilize one of the N services available to the tenant through an SLA, but then that service relies upon one of the M other software service to respond to the tenant's requests). The following disclosure provides various solutions to technical problems associated with managing software services.

### BRIEF DESCRIPTION OF THE DRAWINGS

FIG. 1 illustrates a system for managing software services according to an embodiment.

FIG. 2 illustrates a method for managing software services according to an embodiment.

FIG. 3A illustrates an example system for receiving availability data from software services according to an embodiment.

FIG. 3B illustrates an example system for receiving usage data and dynamically selecting software services for application services according to an embodiment.

FIG. 4 illustrates a method of selecting a software service according to another embodiment.

FIG. 5 illustrates hardware of a special purpose computing system configured according to the above disclosure.

### DETAILED DESCRIPTION

Described herein are techniques for managing software services. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

In some embodiments, the present disclosure includes a technique for selecting the most appropriate third-party services for tenants, which substantially ensures that tenants' SLAs are approximately met but also minimizes the cost of SaaS providers.

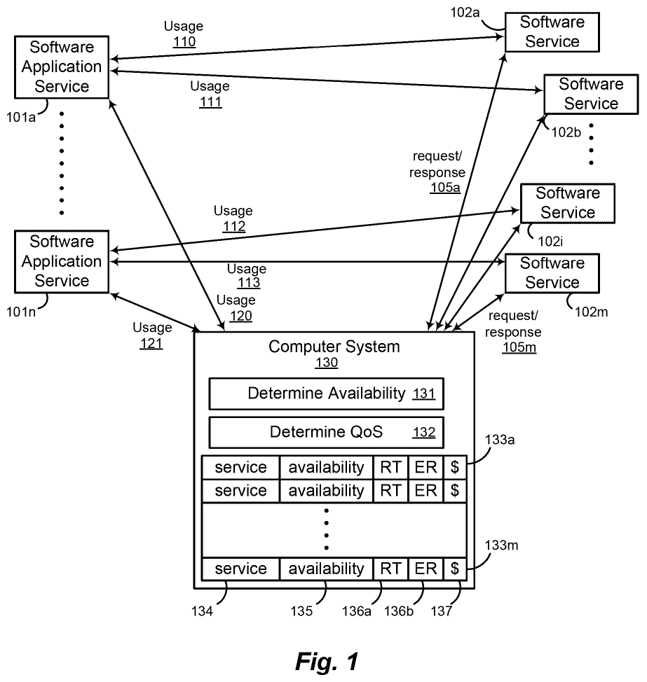

FIG. 1 illustrates a system for managing secondary software services according to an embodiment. Features and advantages of the present disclosure include optimizing the secondary software service used by various primary software application services. Primary software application services 101a-n are software components of a software application, which may use secondary software services 102a-m (e.g., M secondary software services, where M is an integer) external to the software application and its associated primary software application services. A particular software application may have many software application services 101a-n, for example. Additionally, other software applications may also use one or more of software application services 102a-m. In some embodiments, a software application may be a multi-tenant application, where each user group (e.g., employees of a company using the application) is referred to as a tenant. Different tenants of a software application may use some or all of the primary software application services 101a-n. That is, each tenant will utilize different resources available from the SaaS provider under the terms of each tenants' SLA. In some cases, each tenant may have different usage requirements (e.g., service level agreements where the application provider must ensure a minimum usage performance level, such as a minimum error rate or minimum response time). Furthermore, particular functionality of a particular secondary software service 102a-m may be offered and therefore used by primary software application services 101a-n to achieve a particular objective (e.g., multiple map software services in the group of 102a-m may be available from different map service providers and accessible by multiple hotel companies offering information about their properties, including locations and directions obtained from the map software services, through primary software application services 101a-n). Some embodiments may optimize selection of secondary software services 102a-m for primary software application services 101a-n based on usage performance data, price, or both, for example. In general, primary software application services 101a-n are licensed to tenants under an SLA from the SaaS provider while the second software services 102a-m are not licensed under those particular SLAs (but there may be other SLAs involved) directly to the tenants, but whose functionality and operations are relied upon, when needed, by the primary software application services 101a-n.

For example, computer system 130 may include software to determine availability of the secondary software services 102a-m. Computer system 130 may send requests to secondary software services 102a-m, and secondary software services 102a-m answers those requests with corresponding responses (e.g., request/responses 105a-m). When responses are received in computer system 130, they are analyzed to determine the overall health or functionality of the responding secondary software service 102a-m (e.g., response time or accuracy of the response). The results of this analysis may be stored in a storage system, such as in a memory in the form of a table, database, or other data storage mechanism. Based on the responses compared to the corresponding request (e.g., accuracy) and metadata associated with the response (e.g., response time), computer system 130 may determine availabilities of the secondary software services 102a-m. For example, if there are many error responses (e.g., above a set threshold) or the response time is very large (e.g., above another set threshold), determine availability software 131 may produce an indicator of unavailability (e.g., the secondary service 102a-m in a down state or offline). Alternatively, if the error responses are low (e.g., below a set threshold) or the response time is low (e.g., below another set threshold), determine availability software 131 may produce an indicator of availability in an up state (aka, available). The request/response messages and determination of availability may be performed periodically to measure the availability of each software service 102a-m on a regular basis. It should be noted that the designation of available/unavailable is based on the most recent determination. In other words, a secondary service 102a-m could be designated as unavailable in one time period but then be designated as available in the next time period (e.g., 1, 5 or 10 minutes later) when determine availability software 131 conducts its next round of analysis. Once determined, computer system 130 may store the indicators of availability 135 associated with the secondary software services 134 in the storage system (e.g., a table in a memory). In this example, each row of a table 133a-m includes each unique secondary software service 102a-m with its associated availability 135.

In addition to the relative immediacy of determine availability software 131 to determine available/unavailable, computer system 130 gathers usage data from primary software application services 101a-n to associate quality of service (QoS) values with each software service 102a-m. These QoS values are obtained from the various primary software application services 101a-n that interact with the various secondary software services 102a-m. As each primary software application service 101a-n sends a request to a secondary service 102a-m, the time it takes for the secondary software service 102a-m to respond to that request and the accuracy of that response is forwarded to computer system 130. These values are aggregated over time for each of the secondary software services 102a-m and corresponding values are stored as mean response time 136a and mean error rate 136b. These QoS values 136a-b differ from the availability ranking 135 in that the QoS values 136a-b are collected over a longer period (e.g., hours, days, etc) to provide a more historical view of the operational health of each secondary software service 102a-m.

As stated earlier, each primary software application service 101a-n (across potentially multiple applications or tenants of a single application) interacts with a one or more secondary software services 102a-m. For example, a map component of an application (e.g., application service 101a) may be able to interact with different mapping software services (e.g., software services 102a/102b) for mapping functions (e.g., for different applications, different tenants, or different instances of the application). Such a map component of a primary software application server 101a-n may have limited functionality such that it relies heavily, if not exclusively, on a secondary software service 102a-m (e.g., primary software application service 101a-n may merely have an API to call a secondary software service 102a-m). Similarly, primary software application service 101n is shown in FIG. 1 as interacting with secondary software services 102i and 102m. As each primary software application service 101a-n interacts with various secondary software services 102a-m, usage performance data (e.g. usage data 110-113) is gathered. Usage performance data may include response times and success statuses (e.g., erroneous transactions) as previously stated.

Computer system 103 receives the usage performance data for secondary software services 102a-m from primary software application services 101a-n. In some embodiments, each primary software application service 101a-n may send usage performance data periodically or in real-time. In other embodiments, usage performance data may be sent to computer system 130 by an application that collects usage performance data from resident application services and forwards the data to computer system 130 periodically or in real-time, for example. Computer system 130 may include a determine QoS software component 132 for determining QoS values for secondary software services 102a-m based on the usage performance data. Examples of QoS software component 132 may involve a) taking an average of the received usage data, b) taking a mean of the received usage data, c) selecting the worst performer (e.g., the longest response time in a given period). Other examples are contemplated within the scope of this disclosure.

Computer system 130 may store the QoS values associated with the secondary software services 102a-m in the storage system described above. Here, each QoS value 136a and 136b is stored and associated with particular secondary software services 102a-m. Each secondary software service dataset is stored in a particular row with associated availability of QoS values, for example. As described in more detail below, secondary software services data stored in each row may be further associated in the storage system with other attributes, such as a price (“$”) 137 or other category (not shown). As mentioned above, a primary software application service 101a-n may interact with potentially multiple alternative secondary software services 102a-m to perform a particular function (e.g., maps, weather, stocks, etc. . . . ). Thus, multiple secondary software services 102a-m may be associated with the same category (e.g., a map category, weather category, etc. . . . ).

Embodiments of the present disclosure may allow software applications to select particular software services based on the stored availability indicators and QoS values stored on computer system 130. For example, a particular software service out of software services 102a-m may be selected based on an associated indicator of availability and an associated QoS. For example, if a particular software application service can utilize any of a plurality of software services (e.g., for a particular function) having a QoS greater than a particular threshold, computer system 130 may select one of the services having an availability set to “available” and a QoS greater than the threshold. In some embodiments, computer system 130 may further store a URL for each software service 102a-m in the storage system (e.g., associated with the particular service). When a particular software service is selected, computer system 130 may send the URL to the particular application service (or to the application of which the application service is a part) for use in calling the selected software service, for example. Accordingly, software application services may dynamically change the software services they use, thereby overcoming a number of technical problems, such as service failures or service overloads, for example. As mentioned above, price may also be used as a selection factor in some embodiments, thereby allowing the application services 101a-n to dynamically select the most cost effective service, for example.

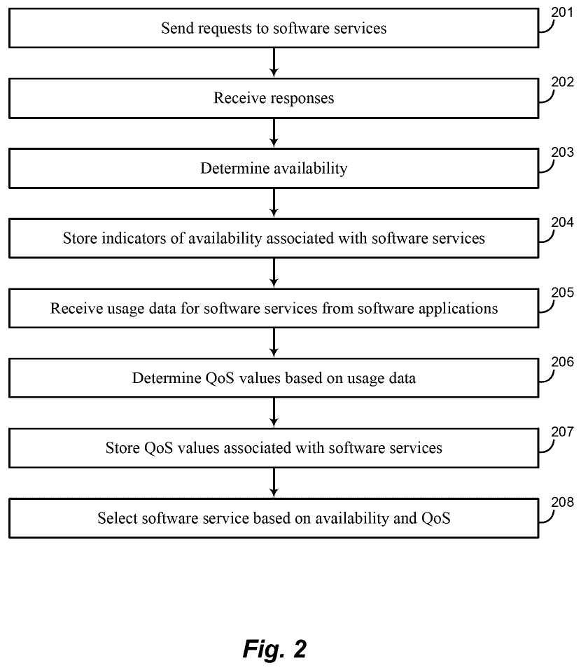

FIG. 2 illustrates a method for managing software services according to an embodiment. At 201, requests are sent (e.g., by a centralized computer system) to a plurality of software services. The plurality of software services, upon receiving the requests, respond to the plurality of requests with a plurality of responses. At 202, the responses are received in the computer system. At 203, the system determines availabilities of the software services based on the plurality of responses. At 204, a plurality of indicators of availability are generated, based on the determined availabilities, and stored in association with each of the software services in a storage system. At 205, usage performance data for the software services is received in the computer system from a plurality of software application services. At 206, QoS values are determined for the software services based on the usage performance data. At 207, the QoS values are associated with their corresponding software services and stored in the storage system. At 208, software application services may request the best, available software service, and software services are selected based on indicators of availability and QoS values.

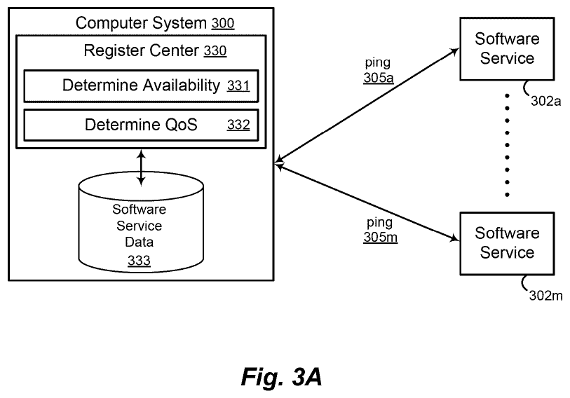

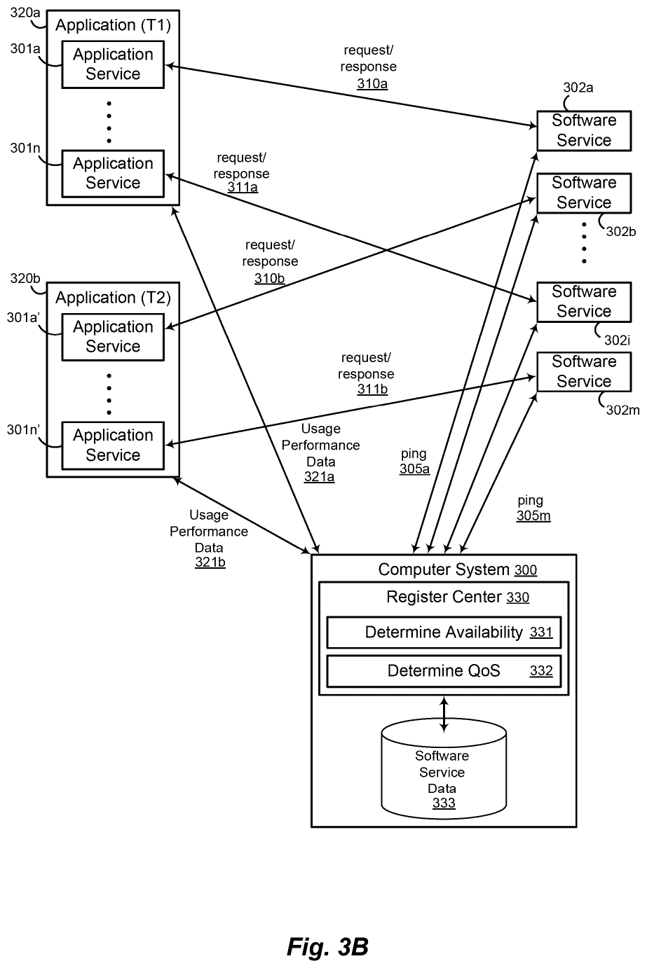

FIG. 3A illustrates an example system for receiving availability data from secondary software services according to an embodiment. As shown in FIG. 3, computer system 300 executes register center software 330, which is used, among other things, register services so they can be discovered and utilized and to monitor the availability of third-party or secondary services using determine availability software module 331 and monitors QoS using determine QoS module 332. The register center 330 sends the ping requests (305a-m) to the third-party, secondary software services 302a-m periodically. These ping requests are simpler than other requests in that they are intended to receive a simple response back. In this case, it is the mere reception of the ping response, and not the accuracy of any operations executed (e.g., FIG. 1) that is determined. Based on the responses, determine availability software 331 stores an availability indicator. For example, if during a specified time period, there are no responses at all, a subset of responses (e.g., 10 pings are sent to one secondary, third-party service like 302a but only 5 ping responses are received) or the response time for one or more ping responses is very large (e.g., greater than a threshold), the register center marks the availability as down in data storage system 333. The following Table 1 illustrates an example data structure of monitor results.

TABLE 1

| | Service | | | |
|---|---|---|---|---|
| Category | name | Price | URL | Availability |
| map | service1_1 | 1.1 | https://domain1_1 | Y |
| positioning | service1_2 | 1.1 | https://domain1_2 | Y |
| | service1_3 | 1.2 | https://domain1_3 | Y |
| | service1_4 | 1.3 | https://domain1_4 | N |
| | . . . | | . . . | . . . |
| weather | service2_1 | 1.1 | https://domain2_1 | N |
| forecast | service2_2 | 1.2 | https://domain2_2 | Y |
| | service2_3 | 1.3 | https://domain2_3 | Y |
| | service2_4 | 1.4 | https://domain2_4 | Y |
| | . . . | | . . . | . . . |
| . . . | service3_1 | 1.0 | https://domain3_1 | Y |
| | . . . | | . . . | . . . |

In this example, data storage 333 stores a variety of third party or secondary software service data. Each third party or secondary software service 302a-m is associated with a category, a service name, a price, a URL (sent to applications services to access the software service), and an availability indicator. Computer system 300 uses this data stored in software service data 333 to instruct primary software application services (e.g., see FIG. 1, 101a-n) which of the third party or secondary software services 302a-m to use to conduct its operations. As an example, suppose a primary application service used by a hotel obtains location and map functionality from a third party or secondary service 302a-m, computer system 300 can instruct the primary application service to use one of the map positioning services service1_1, service 1_2 or service 1_3 to obtain map functionality. Computer system 300 would not instruct the primary application service to utilize service 1_4 as it has determined it is unavailable. Computer system 300 can provide its recommendation instruction to the primary software application service proactively or pushing it (e.g., once in a given time period it provides the list of available third party or secondary service and corresponding URLs)) or reactively or pulling (e.g., primary software application service needs map functionality for a tenant request and requests from computer system 300 which one to use and computer system 300 responds with one or more available third party or secondary services and their corresponding URLs).

FIG. 3B illustrates an example system for receiving usage data and dynamically selecting software services for application services according to an embodiment. FIG. 3B can represent alternative implementations. In one implementation, some of the tenants, such as tenant (T1), has many, if not all, of its required primary application services 301a-n located on its proprietary datacenter. That is, application 320a is used exclusively by tenant (T1) (e.g., an on premise implementation). Alternatively, each tenant of the SaaS provider generates its own instance of an application (tenant (T1) has application 320a instantiated for its use and tenant (T2) has application 320b instantiated for its use). Each instantiated instance of an application uses one or more primary application services that are also instantiated for each tenant.

As mentioned above, register center 330 may periodically monitor QoS of third party or secondary software services 302a-m by obtaining usage performance data from applications 320a or 320b or primary application services 301a-n or 301a′-n′ using those secondary services 302a-m. In this example, an application instance 320a for a first tenant (T1) may include primary application services 301a-n and an application instance 320b for a second tenant (T2) may also include primary application services 301a′-n′. Application 302a may be subject to particular software license agreement (SLA) or other terms of service, which require particular performance levels. Application 302b may be subject to other SLAs or other terms of service, which require different performance levels. As an example, tenant (T1) will have a different agreement from tenant (T2) such that resource utilization and performance expectations will be different between the two tenants. These SLAs may specify performance expectations for each tenant as minimum QoS values for each tenant. Accordingly, minimum QoS values are stored and associated with each tenant of a software application service. Such values may be stored locally on register center 330 or stored remotely and sent to register center 330 when they are used as described below, for example.

A SaaS system including multiple application tenant instances 302a and 302b may continuously request data or operations from third-party or secondary software services 302a-m. For example, application service 301a (tenant 1) may send a request to and receive a response 310a from third party or secondary software service 302a, application service 301a′ (tenant 2) may send a request to and receive a response from 310b third party or secondary software service 302b (which may offer different QoS than 302a in the same category), application service 301n (tenant 1) may send a request to and receive a response from 311a third party or secondary software service 302i, and application service 301n′ (tenant 2) may send a request to and receive a response from 311b third party or secondary software service 302m (which may offer different QoS than 302i in the same category), for example. Once the application services 301a-n and 301a′-n′ of the SaaS system complete each remote call or request to the third-party secondary service, the usage performance data (aka metrics data, such as response time and success status) for each software service is sent to the register center 330 as Usage Performance Data 321a and 321b. It is to be understood that a wide variety of application service configurations may be used to gather performance data from software services 302a-m, and the above example is merely illustrative.

The register center 330 receives the usage performance data 321 and 321b from the requests and responses between primary application services 301a-n and 301a′-n′ and secondary software services 302a-m and periodically calculates the QoS for each secondary software services 302a-302m using determine QoS component 332. For example, in a time window, the register center receives the usage performance data for N application service calls or requests to a particular software service1_1. For the N calls, there are M failed calls to software service1_1, and (N-M) successful calls to software service1_1. The response times for calls or requests to software service1_1 is {t₁, t₂, t₃, . . . , t_{N}}, Determine QoS 332 of register center 330 calculates the mean response time of software service1_1 in that time window of collected usage performance data as follows:

$$MEAN\_RESPONSE \_TlME = \frac{1}{N} {\sum }_{i = 1}^{N} {t}_{i}$$

However, in some embodiments, the response time may be calculated only for the correct request and exclude the incorrect request. The response times for successful calls or requests to software service1_1 is {t_(s,1),t_(s,2),t_(s,3), . . . ,t_(s,N-M)}, the formula is as following:

$$MEAN\_RESPONSE \_TlME = \frac{1}{N - M} {\sum }_{i = 1}^{N - M} {t}_{i}$$

Determine QoS 332 of register center 330 calculates the mean error rate of software service1_1 in that time window of collected usage performance data as follows:

$$MEAN\_ERROR \_RATE = \frac{M}{N}$$

The data structure of monitored results in Table 1 is expanded as illustrated in the following Table 2.

TABLE 2

| | | | | | Mean | Mean |
|---|---|---|---|---|---|---|
| | Service | | | | response | error |
| Category | name | Price | URL | Availability | time | rate |
| map | service1_1 | 1.1 | https://domain1_1 | Y | 1.0 s | 0.010 |
| positioning | service1_2 | 1.1 | https://domain1_2 | Y | 1.2 s | 0.011 |
| | service1_3 | 1.2 | https://domain1_3 | Y | 0.9 s | 0.022 |
| | service1_4 | 1.3 | https://domain1_4 | N | 1.3 s | 0.015 |
| | . . . | | . . . | . . . | . . . | . . . |
| weather | service2_1 | 1.1 | https://domain2_1 | N | 0.8 s | 0.014 |
| forecast | service2_2 | 1.2 | https://domain2_2 | Y | 1.0 s | 0.024 |
| | service2_3 | 1.3 | https://domain2_3 | Y | 1.1 s | 0.009 |
| | service2_4 | 1.4 | https://domain2_4 | Y | 1.3 s | 0.018 |
| | . . . | | . . . | . . . | . . . | . . . |
| . . . | service3_1 | 1.0 | https://domain3_1 | Y | 1.8 s | 0.020 |
| | . . . | | . . . | . . . | | |

Accordingly, in some embodiments, to be selected, a secondary software service must be available and its corresponding one or more of the QoS values are greater than a minimum QoS value (e.g., from an SLA) associated with the particular tenant accessing the software service, for example.

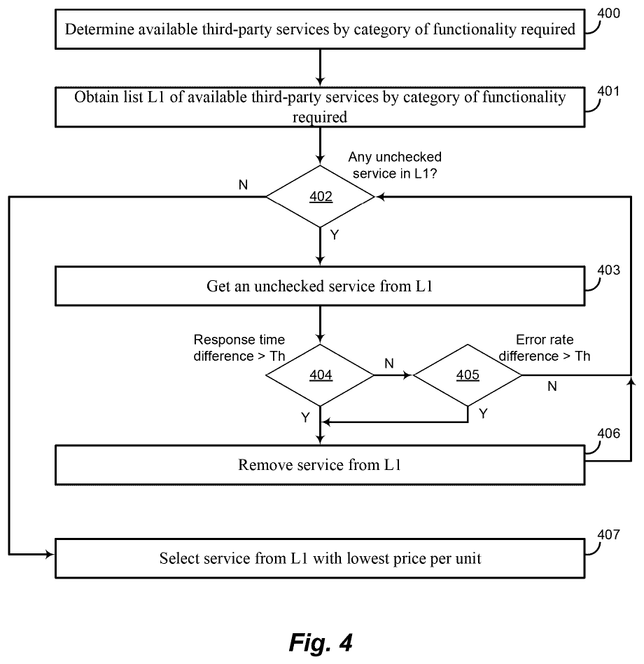

FIG. 4 illustrates a method of selecting a software service according to another embodiment. In this example, when a tenant accesses a SaaS application, if they need to call or make a request to a third-party API to access a software service, the following steps may be performed to select the most appropriate API. At 400, the system determines available third-party services by category of functionality required. At 401, a list L1 is obtained of available third-party software services from the registry center based on the category of functionality required. Thus, software services that the system has determined to be unavailable are not included in the list L1. At 402, the system initiates an iterative process of checking the services in L1. Over the iterations, the system may compare the determined QoS of each service in list L1 to the SLA minimums. At 403, a first unchecked service from L1 is retrieved. In this example, at 404, the system determines if a stored response time and error rate, from Table 2, are sufficient to meet the SLA response time and error rate. For instance, if a difference between the QoS parameters (Response Time, Error Rate) of the tenant's SLA and the detected and stored QoS parameters (Mean Response Time, Mean Error Rate) of the service in Table 2 is greater than a first threshold and second threshold (e.g., T_responseTime or T_errorRate) at 404 or 405, the service is removed from the list L1 at 406. This ensures that the tenant's SLA is not violated. In some embodiments, the thresholds T_response Time and T_errorRate are adjustable to change the margin required, for example. If both thresholds are satisfied, the system may select a service from the list L_1 with the lowest price per unit, for example. Accordingly, advantages of the present example may not only ensure SLAs for tenants are met, but also minimize costs for SaaS providers, for example.

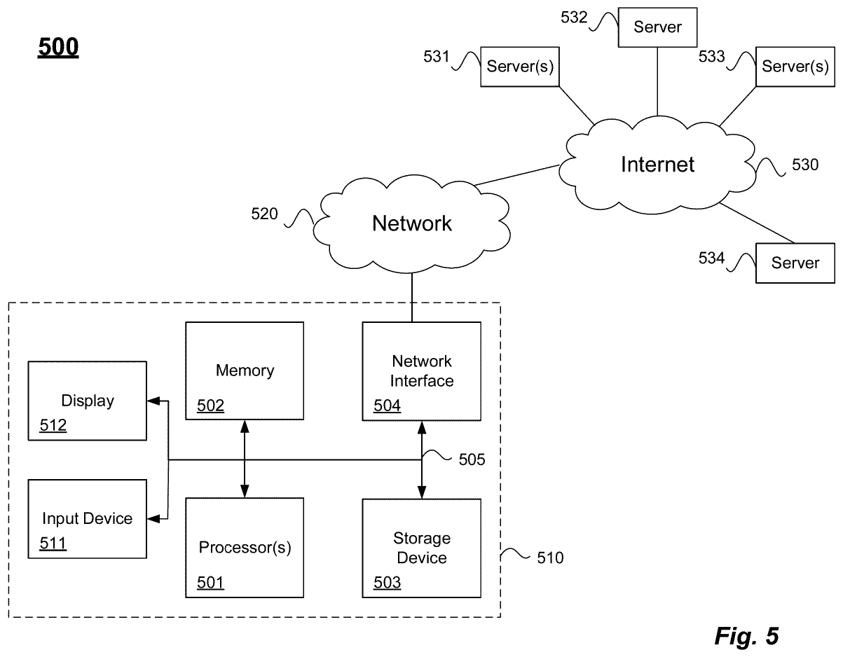

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a method comprising: sending, in a computer system, a plurality of requests to a plurality of software services, the plurality of software services responding to the plurality of requests with a plurality of responses; receiving the plurality of responses in the computer system; determining, by the computer system, a plurality of availabilities corresponding to the plurality of software services based on the plurality of responses; storing, by the computer system, a plurality of indicators of availability, based on the plurality of availabilities, associated with each of the plurality of software services in a storage system; receiving, in the computer system from a plurality of software application services, usage performance data for the plurality of software services; determining, by the computer system, one or more quality of service values for the plurality of software services based on the usage performance data; storing, by the computer system, the one or more quality of service values associated with the plurality of software services in the storage system; and selecting, for use by a first software application service of the plurality of software application services, a first software service of the plurality of software services based on a first indicator of availability and a first quality of service value associated with the first software service.

In one embodiment, a particular indicator of availability associated with a particular software service corresponds to a down state when a number of error responses exceeds a first threshold or when a response time exceeds a second threshold.

In one embodiment, the plurality of software services are further associated with a plurality of categories in the storage system.

In one embodiment, the plurality of software services are further associated with at least one price in the storage system, wherein selecting comprises selecting the first software service being associated with: the first indicator of availability indicating the first software service is available, the first quality of service value is greater than a predefined value for a first tenant of the first software application service, and a lowest price in a first category associated with the first software service.

In one embodiment, the method further comprises storing a plurality of URLs associated with the plurality of software services.

In one embodiment, the usage performance data comprises a response time.

7 In one embodiment, the method further comprises: calculating a plurality of mean response times for the plurality of software services; and storing the plurality of mean response times in the storage system associated with the plurality of software services, wherein the first quality of service value is based on one of the plurality of mean response times.

In one embodiment, the usage performance data comprises a plurality of success statuses.

9 In one embodiment, the method further comprises: calculating a plurality of mean error rates from the plurality of success statuses for the plurality of software services; and storing the plurality of mean error rates in the storage system associated with the plurality of software services, wherein the first quality of service value is based on one of the plurality of mean error rates.

In one embodiment, the method further comprises storing a plurality of minimum quality of service values associated with tenants of a software application service, wherein the first quality of service value is greater than a first minimum quality of service value associated with a first tenant accessing the first software service.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
sending, in a computer system, a plurality of requests to a plurality of software services, the plurality of software services responding to the plurality of requests with a plurality of responses;
receiving the plurality of responses in the computer system;
determining, by the computer system, a plurality of availabilities corresponding to the plurality of software services based on the plurality of responses;
storing, by the computer system, a plurality of indicators of availability, based on the plurality of availabilities, associated with each of the plurality of software services in a storage system;
receiving, in the computer system from a plurality of software application services, usage performance data for the plurality of software services;
determining, by the computer system, one or more quality of service values for the plurality of software services based on the usage performance data;
storing, by the computer system, the one or more quality of service values associated with the plurality of software services in the storage system; and
selecting, for use by a first software application service of the plurality of software application services, a first software service of the plurality of software services based on a first indicator of availability and a first quality of service value associated with the first software service.

2. The method of claim 1, wherein a particular indicator of availability associated with a particular software service corresponds to a down state when a number of error responses exceeds a first threshold or when a response time exceeds a second threshold.

3. The method of claim 1, wherein the plurality of software services are further associated with a plurality of categories in the storage system.

4. The method of claim 3, wherein the plurality of software services are further associated with at least one price in the storage system, wherein selecting comprises selecting the first software service being associated with:
the first indicator of availability indicating the first software service is available,
the first quality of service value is greater than a predefined value for a first tenant of the first software application service, and
a lowest price in a first category associated with the first software service.

5. The method of claim 1, further comprising storing a plurality of URLs associated with the plurality of software services.

6. The method of claim 1, wherein the usage performance data comprises a response time.

7. The method of claim 6, further comprising:
calculating a plurality of mean response times for the plurality of software services; and
storing the plurality of mean response times in the storage system associated with the plurality of software services,
wherein the first quality of service value is based on one of the plurality of mean response times.

8. The method of claim 1, wherein the usage performance data comprises a plurality of success statuses.

9. The method of claim 8, further comprising:
calculating a plurality of mean error rates from the plurality of success statuses for the plurality of software services; and
storing the plurality of mean error rates in the storage system associated with the plurality of software services,
wherein the first quality of service value is based on one of the plurality of mean error rates.

10. The method of claim 1, further comprising storing a plurality of minimum quality of service values associated with tenants of a software application service, wherein the first quality of service value is greater than a first minimum quality of service value associated with a first tenant accessing the first software service.

11. A computer system comprising:
at least one processor;
at least one non-transitory computer-readable medium storing computer-executable instructions that, when executed by the at least one processor, cause the computer system to perform a method comprising:
sending, in a computer system, a plurality of requests to a plurality of software services, the plurality of software services responding to the plurality of requests with a plurality of responses;
receiving the plurality of responses in the computer system;
determining, by the computer system, a plurality of availabilities corresponding to the plurality of software services based on the plurality of responses;
storing, by the computer system, a plurality of indicators of availability, based on the plurality of availabilities, associated with each of the plurality of software services in a storage system;
receiving, in the computer system from a plurality of software application services, usage performance data for the plurality of software services;
determining, by the computer system, one or more quality of service values for the plurality of software services based on the usage performance data;
storing, by the computer system, the one or more quality of service values associated with the plurality of software services in the storage system; and
selecting, for use by a first software application service of the plurality of software application services, a first software service of the plurality of software services based on a first indicator of availability and a first quality of service value associated with the first software service.

12. The computer system of claim 11, wherein a particular indicator of availability associated with a particular software service corresponds to a down state when a number of error responses exceeds a first threshold or when a response time exceeds a second threshold.

13. The computer system of claim 11, wherein the plurality of software services are further associated with a plurality of categories in the storage system.

14. The computer system of claim 11, wherein the usage performance data comprises a plurality of response times and a plurality of success statuses.

15. The computer system of claim 11, further comprising storing a plurality of minimum quality of service values associated with tenants of a software application, wherein the first quality of service value is greater than a first minimum quality of service value associated with a first tenant accessing the first software service.

16. A non-transitory computer-readable medium storing computer-executable instructions that, when executed by at least one processor of a computer system, perform a method comprising:
sending, in a computer system, a plurality of requests to a plurality of software services, the plurality of software services responding to the plurality of requests with a plurality of responses;
receiving the plurality of responses in the computer system;
determining, by the computer system, a plurality of availabilities corresponding to the plurality of software services based on the plurality of responses;
storing, by the computer system, a plurality of indicators of availability, based on the plurality of availabilities, associated with each of the plurality of software services in a storage system;
receiving, in the computer system from a plurality of software application services, usage performance data for the plurality of software services;
determining, by the computer system, one or more quality of service values for the plurality of software services based on the usage performance data;
storing, by the computer system, the one or more quality of service values associated with the plurality of software services in the storage system; and
selecting, for use by a first software application service of the plurality of software application services, a first software service of the plurality of software services based on a first indicator of availability and a first quality of service value associated with the first software service.

17. The non-transitory computer-readable medium of claim 16, wherein a particular indicator of availability associated with a particular software service corresponds to a down state when a number of error responses exceeds a first threshold or when a response time exceeds a second threshold.

18. The non-transitory computer-readable medium of claim 16, wherein the plurality of software services are further associated with a plurality of categories in the storage system.

19. The non-transitory computer-readable medium of claim 16, wherein the usage performance data comprises a plurality of response times and a plurality of success statuses.

20. The non-transitory computer-readable medium of claim 16, further comprising storing a plurality of minimum quality of service values associated with tenants of a software application, wherein the first quality of service value is greater than a first minimum quality of service value associated with a first tenant accessing the first software service.
